(19) United States
(12) Patent Application Publication
(10) Pub. No.: US 2008/0120138 A1
(43) Pub. Date: May 22, 2008

(54) SYSTEMS AND METHODS FOR AUTOMATIC SEVERITY RANKING AND NOTIFICATION SYSTEM

(75) Inventors: Mark Morita, Arlington Heights, IL (US); Prakash Mahesh, Hoffman Estates, IL (US); Murali Kumaran Kariathungal, Hoffman Estates, IL (US)

Correspondence Address: MCANDREWS HELD & MALLOY, LTD, 500 WEST MADISON STREET, SUITE 3400, CHICAGO, IL, 60661, US

(73) Assignee: GENERAL ELECTRIC COMPANY, Schenectady, NY (US)

(21) Appl. No.: 11/562,839

(22) Filed: Nov. 22, 2006

(51) Int. Cl. G06Q 50/00

(52) U.S. Cl. 705/3

(57) ABSTRACT

Certain embodiments of the present invention provide a method for automatic prioritizing and ranking of patients in a medical center. The method includes acquiring medical information associated with a patient, prioritizing and ranking the patient based on the acquired medical information, and routing the patient's medical information to an appropriate practitioner based on the priority and rank of the patient.

### BACKGROUND OF THE INVENTION

The present invention generally relates to a medical notification system. In particular, the present invention relates to systems and methods for automatic severity ranking and notification.

Medical practitioners, such as doctors, surgeons, and other medical professionals, often rely on reading and assessing patients' information to determine the priority of the patients' conditions. In most situations there are multiple patients and their conditions usually have different priorities and need to be ranked in order of that priority to determine the order in which the patients need to receive care. This process is extremely time-consuming and can result in leaving the medical practitioners less time to actually take care of the patients and tend to their conditions that would have required attention earlier.

Typical healthcare information technology (IT) systems may be able to provide some automation of the process of healthcare. For example, the patients' information can be entered and made available electronically to medical practitioners in lists according to name, medical record number, or a specific time a procedure or order had taken place. However, the medical practitioners still have to go through the list of patients to determine the priority that should be assigned to each patient's case based on all the data entered in the patient's record.

Therefore current healthcare systems rely heavily on manual observation by medical practitioners, which can be very time-consuming. An additional problem associated with basing priorities of patients' conditions on human observation is the variation in the observations from one medical practitioner to another. One medical practitioner cannot observe all the lists of patients simultaneously, and therefore the results will reflect the variation in the observations and conclusions made from one person to another.

Additionally, once a medical practitioner or healthcare provider has reviewed a patient's procedure or record, it is extremely difficult to immediately notify other medical practitioners or healthcare providers. Some of the things that an observing practitioner wants to relay to other practitioners are that a diagnosis or procedure has been completed; that recommendations or follow-up steps are available; and confirming that the ordering physician or provider has received the information in a timely manner.

Thus, there is a need for systems and methods that automate the process of ranking and prioritizing patients and their clinical procedures.

### BRIEF SUMMARY OF THE INVENTION

Certain embodiments of the present invention provide a method for automatic prioritization and ranking of patients in a medical center. The method may include acquiring medical information associated with a patient; automatically prioritizing and ranking the patient based on the acquired medical information; and automatically routing the patient's medical information to an appropriate practitioner based on the priority and rank of the patient.

Certain embodiments of the present invention provide a computer readable storage medium. The computer readable storage medium includes a set of instructions for execution on a computer. The set of instructions includes an input routine configured to acquire medical information associated with a patient, a prioritizing routine configured to automatically prioritize and rank the patient based on the acquired medical information, and a routing routine configured to automatically route the patient's medical information to an appropriate practitioner based on the priority and rank of the patient.

Certain embodiments of the present invention provide an input device that acquires medical information associated with a patient, and at least one processor that enables automatic prioritizing and ranking the patient based on the acquired medical information. The at least one processor enables automatic routing the patient's medical information to an appropriate practitioner based on the priority and rank of the patient.

### BRIEF DESCRIPTION OF SEVERAL VIEWS OF THE DRAWINGS

FIG. 1 illustrates a medical network system used in accordance with an embodiment of the present invention.

FIG. 2 illustrates a block diagram of a prioritization and ranking system, in accordance with an embodiment of the present invention.

FIG. 3 illustrates a flowchart of a method for automatic prioritizing and ranking in a medical network system in accordance to an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

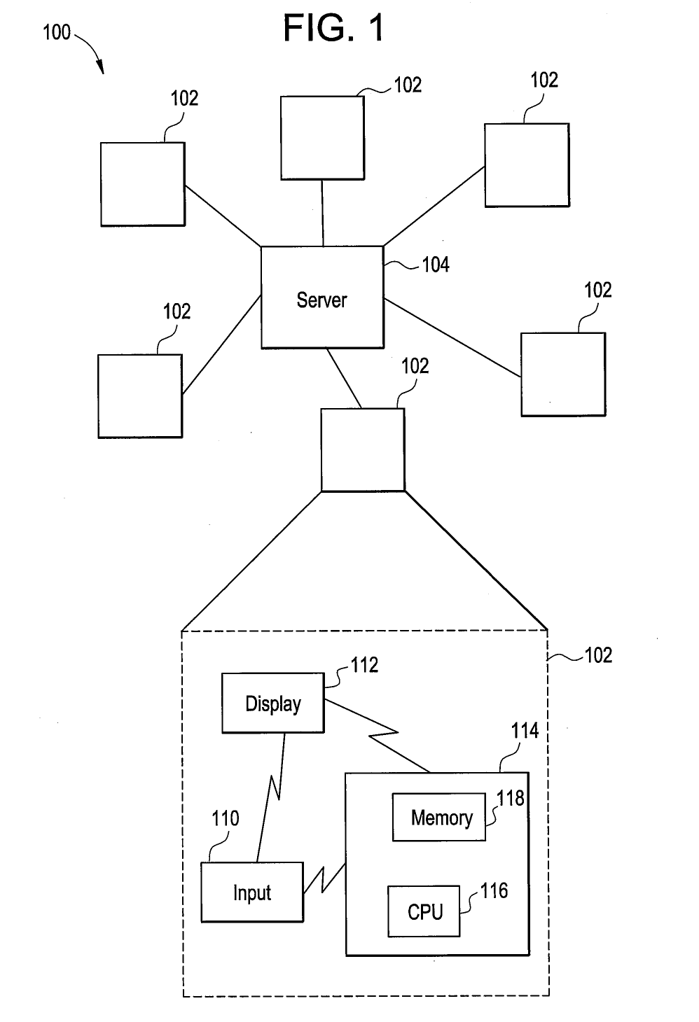

Referring now to FIG. 1, an exemplary medical network is illustrated. The medical network system 100 may be utilized in a medical center such as, for example, a hospital or a radiology center. The medical network system 100 may include several medical stations 102 communicatively coupled through a central server 104. Each of the medical stations 102 may include an input device 110, a display device 112, and a computing and processing device 114. A medical station 102 may be, for example, set up in an examining room where a patient may be examined for a medical condition.

The input device 110 may be, for example, a keyboard that may be used by a medical practitioner to enter information regarding a patient being examined or observed by the medical practitioner. The input device 110 may also be equipped or connected to other medical devices that may provides measures and readings of a patient's medical information, such as, image acquisition devices (e.g., an ultrasound scanner, a magnetic resonance imaging (MRI) scanner, a positron emission tomography (PET) scanner, a computed tomography (CT) scanner, a X-ray scanner, etc.), or an electrocardiograph (ECG), or a heart rate monitor, etc. The display device 112 may be utilized to read patients' records at any one of the medical stations 102.

The input device 110 may be used by a medical practitioner to enter information regarding the patient and his/her medical condition. The input device 110 may also receive automatic readings from medical devices connected thereto, which may also be connected to a patient. The information received by the input device 110 may be transmitted to the computer and processing device 114 and may also be displayed on the display device 112.

The computing and processing device 114 may include hardware and/or software capable of processing the received information. The computing and processing device 114 may also include a processor 116 and memory 118. The computing and processing device 114 may process the received information and aggregate the received information with other information related to the same patient and already on the system. The computing and processing device 114 may then use a set of rules to process the patient's information and prioritize and rank the severity of the patient's condition. The information may be processed and priorities and rankings may be assigned in real time. Every time more recent information is entered for a patient, his/her records may be updated, and a new priority and ranking of the patient's condition may be assigned based on the new conditions or observations.

The computing and processing device 114 may prioritize and rank the severity of a patient's condition in such a way that the most acute cases may be communicated and presented to a medical practitioner immediately and less acute cases may be communicated and presented with less urgency. While the computing and processing device 114 is processing the patient's input information, the patient databases may be queried to extract information such as reason for exam, prior reports, radiology wet reads, allergies, problem lists, etc. All the patient information that is retrieved from the database and that is acquired through the input device 110 may be processed together and aggregated into one listing. Further processing may then process all this aggregate information and make certain determination based on the processing. Such determinations may be, for example, an acuity value, which can be ranked in accordance with other existing patients and procedures.

Once these determinations are made by the computing and processing device 114, the determinations that may include, for example, the priority and ranking of a patient's condition may be made available to other medical stations 102 within the medical network system 100 via the server 104. A medical practitioner may then be able to access the information about the patient's condition along with the patient's record from any one of the medical stations 102. Additionally, the medical station 102 may be a mobile communication device that a medical practitioner may use to continuously be accessible, and the mobile communication device may show a notification message to the appropriate medical practitioner upon determination of a high priority and ranking of a certain patient's condition and/or procedure.

Once a healthcare provider or medical practitioner reviews the patient's information, he/she may add his or her own feedback based on their own observation and/or further examination. The feedback provided by the medical practitioner may include topics such as, for example, diagnosis, findings, stat orders, normal values, no further information, prescriptions, inpatient elective procedure, ED trauma, etc. This information may also be added using an input device 110 and further processed by the computing and processing device 114, which may take the existing acuity value and add any follow-up comments or feedback and add that to an updated acuity value. The values associated with the information entered for the patient may have values associated with them based on a set of rules programmed into the system. Additional actions may also be associated with certain values. For example, if a certain value indicates the presence of a certain ailment, further exams may be ordered to obtain more information about the patient's condition. The rules may also contain information regarding the medical practitioners and their specialties, where certain comments or conditions associated with the patient may trigger communicating the information to a specific medical practitioner whose specialty fits the patient's condition best. The rules may be programmed by the end user, and may be changeable. For example, when a new medical practitioner joins the group of medical practitioners associated with the medical network system 100, his information based on his specialty and experience may be added to the set of rules in the database and programmed to be associated with certain conditions.

Based on the updated acuity value, the information may be routed to the next workflow step based on the follow-up comments. Depending on the severity of the acuity value, the appropriate medical practitioner or healthcare provider in the next step may be notified to ensure that proper care is provided for the patient. For example, a patient may require a stat procedure, in which case, the associated medical practitioner may be notified by stat alert or page immediately. On the other hand, a patient with a small acuity value might be sent home and the follow-up communication to the next level provider may be notified via normal email or perhaps even snail mail.

The medical network system 100 may automatically update the acuity ranking for patient healthcare encounters. The system may also ensure that the acuity ranking is updated through each step in the workflow allowing for follow-up notifications sent with the same priority.

For example, a patient may come in for a chest exam. The patient may be a seven-year-old child for whom other types of information may not be available regarding his chest other than information from a radiology system. The reason for the exam may be indicated as an annual chest report. The system may query other information systems like, for example, electronic medical record. The system may use the queried information to look at the cardiology system and at laboratory results. For the electronic medical record system, the system may look at the patient's information to determine if the patient has any other history of chest pain and/or if there is any other finding in that area. If nothing is found, which would most likely be the case, because this is the first time this exam has been processed, there is no value assigned to it. The system may also check the cardiovascular system to see if the patient has had a volumetric CT (VCT) of the heart for any kind of blood blockage or some other type of chest pain, and if there was, then the system would indicate so. In this case, the patient may not have had any issues there are well, and a coefficient indicating the presence of no urgent medical conditions may be assigned for the patient. In this case, there patient may not be associated with a high priority, and therefore the ranking for the patient's condition may be set to a low number, so that other more urgent cases and patients may be addressed first.

In another exemplary situation, a patient may come in complaining of difficulty breathing and chest pain. The patient may have had a CT of the abdomen. The electronic medical record for the patient may also show that the person has had an irregular heartbeat. The patient may have also had a history of diabetes, and is on X, Y and Z medications that are relevant to the heart. In addition to that, laboratory results may show that the patient's glucose level has been high in the past. Other information in the system may indicate that this patient may be going through some kind of arrhythmia or maybe a heart blockage. Each of the conditions may cause the acuity value to be higher, and the coefficients all added together may indicate to a medical practitioner a much higher value, which may cause the particular patient to be brought to the top of the list of patients and thus indicating the necessity of urgent or immediate medical care.

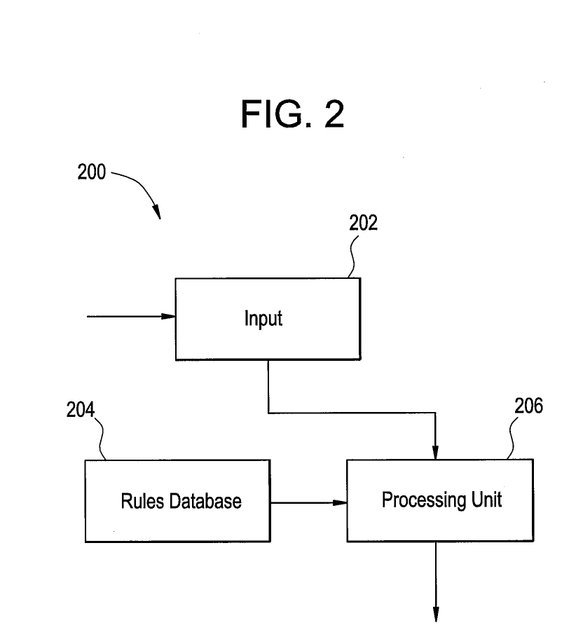

Referring now to FIG. 2, an exemplary block diagram of a prioritization and ranking system 200 is illustrated. The prioritization and ranking system 200 may include an input device 202, a rules database 204, and a computing and processing device 206. The prioritization and ranking system 200 may include hardware and/or software or a combination thereof.

The input device 202 may be, for example, a keyboard that may be used by a medical practitioner to enter information regarding a patient being examined or observed by the medical practitioner. The input device 202 may also be equipped or connected to other medical devices that may provides measures and readings of a patient's medical information, such as, image acquisition devices (e.g., an ultrasound scanner, a magnetic resonance imaging (MRI) scanner, a positron emission tomography (PET) scanner, a computed tomography (CT) scanner, a X-ray scanner, etc.), or an electrocardiograph (ECG), or a heart rate monitor, etc.

The computing and processing device 114 may include hardware and/or software capable of processing the received information. The computing and processing device 114 may process the received information and aggregate the received information with other information related to the same patient and already on the system.

The input device 202 may be utilized to enter values for different medical information related to the patient. The information may be, for example, the reasons for exam, the patient's medical history, the patient's family medical history, laboratory results, etc. Each category of information may provide a set of possible answers from which a medical practitioner may select based on the specific patient being examined. The computing and processing device 206 may then read the answers provided for each of the categories, and may assign numerical values to the answers. The numerical values associated with each of the answers may be stored in the rules database 204. The more urgent a condition, the higher the value assigned to the corresponding answer. The computing and processing device 206 may then further process the information by adding all the values together and updating the value associated with the patient if one is already in existence. The computing and processing device 206 may then update the ranking of the patient amongst all the other patients based on the new updated acuity value. If the acuity value for the patient indicates an urgent medical condition, the appropriate medical practitioner may be contacted immediately to provide the needed medical attention.

The information may be processed and priorities and rankings may be assigned in real time. Every time more recent information is entered for a patient, his/her records may be updated, and a new priority and ranking of the patient's condition may be assigned based on the new conditions or observations.

Cases with higher acuity values may be immediately communicated to a medical practitioner, who may be a specialist in the area of the patient's problem. The medical practitioners may be contacted using a communication method that is immediately available to him or her, or a combination of communication methods to ensure that patients with need for urgent attention receive the needed attention. The communication may be in the form of an alert sent to a working station to which the medical practitioner may have access, a mobile handheld device, email, etc.

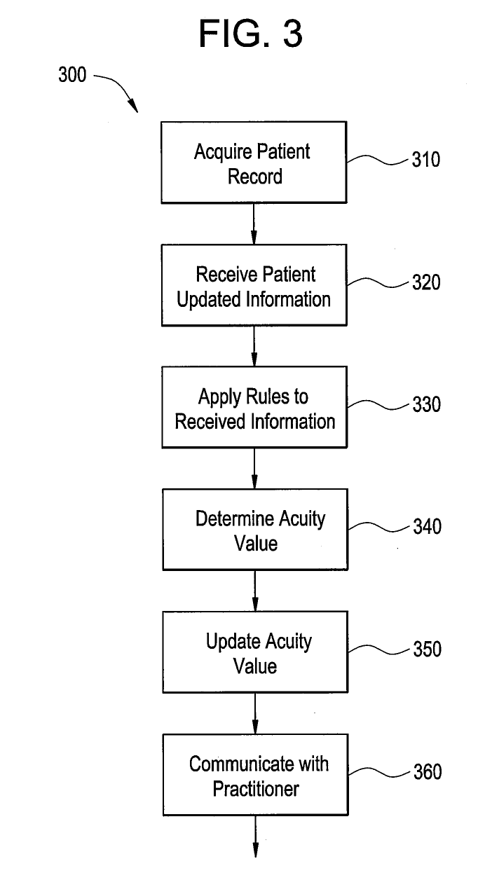

FIG. 3 illustrates a flowchart of a method for automatic prioritizing and ranking in a medical network system, in accordance to an embodiment of the present invention. The method 300 includes the following steps, which are described below in more detail. At step 310, a patient's record is acquired. At step 320, new medical information for the patient is received. At step 330, a set of rules is applied to the newly received information. At step 340, the acuity value is determined for the patient. At step 350, the acuity value for the patient is updated. At step 360, a message is communicated to an appropriate medical practitioner.

At step 310, a patient's record is acquired. A patient visiting a medical center may have an existing record in the system. An existing record may include results of prior exams or conditions associated with the patient. For an existing patient, there may be an associated existing priority and ranking among other patients of the medical center. For a new patient, the record may not contain much information, unless the patient is transferring from another medical center and may have existing information entered for him/her.

At step 320, new medical information for the patient is received. The patient may undergo certain exams and observations by medical practitioners at the medical center. Information acquired through these observations and exams may be entered in to the system by the medical practitioner. Each topic or category covered by the observation may be assigned a value based on the answer or the value entered. Additionally, laboratory results may be also entered into the system as input. The system may include an input device, which may be used by the medical practitioner to enter the patient's medication information. The answers or values associated with different categories may be preset and selected using the input device. Information may also be received from other medical devices connected to the input device such as medical imaging devices, monitoring devices, etc., for example.

At step 330, a set of rules is applied to the newly received information. The selected answers or values for the categories may be processed by the system. The processing may apply a set of rules to the selected values. For example, each of the possible selections in response to each of the categories may have a value associated with it. Additionally, a certain combination of responses may have a value that reflects the effects of a combination of certain conditions.

At step 340, the acuity value is determined for the patient. Once the rules are applied to the responses and conditions of the patient, an acuity value may be determined. In most cases, conditions indicating more severe issues may have higher values associated with them, and as a result a higher acuity value may be associated with the patient. For conditions that are not as urgent, smaller values may be assigned, and as a result, in combination, a smaller acuity value may result.

At step 350, the acuity value for the patient is updated. In many cases the patient may already have an existing acuity value in the system based on previous visits to the medical center. Even in cases where the patient may be a first time patient, a small or zero acuity value may be initially assigned to him. The existing acuity value may be updated with the acuity value determined based on the current condition and exams, resulting in a combined acuity value. Depending on the new acuity value, the ranking of the patient among other patients in the medical center may be updated. For example a higher acuity value may indicate that the patient may need more urgent attention than other patients with lower acuity values, and as a result the ranking of the patient with the higher acuity value may be updated to give him a higher ranking to receive medical care sooner than those with lower acuity values.

At step 360, a message is communicated to an appropriate medical practitioner. Based on the new prioritization and ranking of the patient, a medical practitioner may be alerted to follow up with the patient's condition, in case the determined acuity value for the patient indicates a more urgent condition. For a lower acuity value, the medical practitioner may take steps to deal with the patient accordingly, by sending him home, or giving him instructions or a prescription, for example. A medical practitioner may also determine to have the patient undergo more testing and observation, and the acuity value may be updated accordingly if results show new indications and conditions that necessitate updating of the acuity value.

Several embodiments are described above with reference to drawings. These drawings illustrate certain details of specific embodiments that implement the systems and methods and programs of the present invention. However, describing the invention with drawings should not be construed as imposing on the invention any limitations associated with features shown in the drawings. The present invention contemplates methods, systems and program products on any machine-readable media for accomplishing its operations. As noted above, the embodiments of the present invention may be implemented using an existing computer processor, or by a special purpose computer processor incorporated for this or another purpose or by a hardwired system.

As noted above, embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may include RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Embodiments of the invention are described in the general context of method steps which may be implemented in one embodiment by a program product including machine-executable instructions, such as program code, for example in the form of program modules executed by machines in networked environments. Generally, program modules include routines, programs, objects, components, data structures, etc. that perform particular tasks or implement particular abstract data types. Machine-executable instructions, associated data structures, and program modules represent examples of program code for executing steps of the methods disclosed herein. The particular sequence of such executable instructions or associated data structures represents examples of corresponding acts for implementing the functions described in such steps.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated machine-readable media provide nonvolatile storage of machine-executable instructions, data structures, program modules and other data for the computer.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

Those skilled in the art will appreciate that the embodiments disclosed herein may be applied to the formation of any medical navigation system. Certain features of the embodiments of the claimed subject matter have been illustrated as described herein, however, many modifications, substitutions, changes and equivalents will now occur to those skilled in the art. Additionally, while several functional blocks and relations between them have been described in detail, it is contemplated by those of skill in the art that several of the operations may be performed without the use of the others, or additional functions or relationships between functions may be established and still be in accordance with the claimed subject matter. It is, therefore, to be understood that the appended claims are intended to cover all such modifications and changes as fall within the true spirit of the embodiments of the claimed subject matter.

1. A method for automatic prioritizing and ranking of patients, the method comprising:
acquiring medical information associated with a patient;
automatically prioritizing and ranking the patient based on the acquired medical information; and
automatically routing the patient's medical information to an appropriate practitioner based on the priority and rank of the patient.

2. The method of claim 1, wherein acquiring the medical information comprises selecting a response from a set of responses for each of a plurality of categories.

3. The method of claim 2, wherein each of the plurality of categories comprises a set of questions regarding medical conditions.

4. The method of claim 2, further comprising assigning a value to each of the selected responses.

5. The method of claim 4, further comprising:
determining a total value associated with the patient based on the assigned values;
updating the ranking of the patient according to the determined total value; and
determining an urgency factor of the patient's condition based on the updated ranking.

6. The method of claim 1, wherein the medical information comprises results of medical tests.

7. The method of claim 1, wherein the medical information comprises medical images.

8. A computer readable storage medium including a set of instructions for execution on a computer, the set of instructions including:
an input routine configured to acquire medical information associated with a patient;
a prioritizing routine configured to automatically prioritize and rank the patient based on the acquired medical information; and
a routing routine configured to automatically route the patient's medical information to an appropriate practitioner based on the priority and rank of the patient.

9. The computer readable storage medium of claim 8, wherein the input routine comprises a selecting routine configured to allow selecting a response from a set of responses for each of a plurality of categories.

10. The computer readable storage medium of claim 9, wherein the categories comprise a set of questions regarding medical conditions.

11. The computer readable storage medium of claim 9, wherein the set of instructions further comprise at least one routine configured to assign a value to each of the selected responses.

12. The computer readable storage medium of claim 11, wherein
the at least one routine is configured to determine a total value associated with the patient based on the assigned values;
the at least one routine is configured to update the ranking of the patient according to the determined total value; and
the at least one routine is configured to determine an urgency factor of the patient's condition based on the updated ranking.

13. The computer readable storage medium of claim 8, wherein the medical information comprises results of medical tests.

14. The computer readable storage medium of claim 8, wherein the medical information comprises medical images.

15. A system for automatic prioritizing and ranking of patients, the system comprising:
an input device that acquires medical information associated with a patient; and
at least one processor that enables automatic prioritizing and ranking the patient based on the acquired medical information, the at least one processor enabling automatic routing of the patient's medical information to an appropriate practitioner based on the priority and rank of the patient.

16. The system of claim 15, wherein the medical information is acquired based on the at least one processor enabling selecting a response from a set of responses for each of a plurality of categories.

17. The system of claim 16, wherein the categories comprise a set of questions regarding medical conditions.

18. The system of claim 16, wherein the at least one processor enables assigning a value to each of the selected responses.

19. The system of claim 18, wherein
the at least one processor enables determining a total value associated with the patient based on the assigned values;
the at least one processor enables updating the ranking of the patient according to the determined total value; and
the at least one processor enables determining an urgency factor of the patient's condition based on the updated ranking.

20. The system of claim 15, wherein the medical information comprises results of medical tests.

21. The system of claim 15, wherein the medical information comprises medical images.
